(19) United States
(12) Patent Application Publication
(10) Pub. No.: US 2026/0244211 A1
(43) Pub. Date: Aug. 20, 2026

(54) INFORMATION PROCESSING APPARATUS, CONTROL METHOD, AND COMPUTER-READABLE RECORDING MEDIUM

(71) Applicant: NEC Corporation, Tokyo (JP)

(72) Inventor: Manao MACHIDA, Tokyo (JP)

(73) Assignee: NEC Corporation, Tokyo (JP)

(21) Appl. No.: 19/159,847

(22) PCT Filed: Mar. 1, 2023
(86) PCT No.: PCT/JP2023/007601

§ 371 Date: Aug. 26, 2025

(51) Int. Cl. G05D 1/644; G05D 1/698

(52) U.S. Cl. CPC G05D 1/644; G05D 1/6985

(57) ABSTRACT

An information processing device has: a leader path planning unit that sets a dynamic constraint condition for mobile bodies in a formation which is controlled such that a leader mobile body causes a follower mobile body to follow, and a path constraint condition concerning a path for the leader mobile body based on relative coordinates between the leader mobile body and the follower mobile body, and that generates a path for the leader mobile body in such a manner as to satisfy both the path constraint condition and a waypoint condition concerning a sequence of sets of positions and time points of the leader mobile body on the path; and a follower path planning unit that generates a path for the follower mobile body from the path for the leader mobile body generated by the leader path planning unit.

### TECHNICAL FIELD

The present disclosure relates to an information processing apparatus and a control method for planning a path when a plurality of mobile bodies moves in cooperation, and further relates to a computer-readable recording medium recording a program for achieving the information processing apparatus and the control method.

### BACKGROUND ART

A control method in which a mobile body (hereinafter, referred to as a “leader mobile body” or a “leader”) serving as a small number of leaders follows a mobile body (hereinafter, referred to as a “follower mobile body” or a “follower”) serving as a large number of followers is referred to as leader/follower control. The mobile body is, for example, a robot.

The advantage of the leader/follower control is that if a small number of leaders have high performance, a large number of followers can compensate for the low performance by taking action in response to instructions from the leaders even if the followers have low performance. By using this mechanism, only a part of the mobile bodies need to have high performance without having to have high performance of all the mobile bodies, so that cost reduction and the like can be achieved.

NPL 1 proposes a method in which only the leader grasps the path and moves along the path, and the follower moves so as to maintain a relative position with the leader, thereby forming a formation and moving.

NPL 2 proposes a method of determining only a path for a leader and generating a path for a follower (a path for a follower to move in a formation with the leader) from the path for the leader.

### CITATION LIST

### Non Patent Literature

NPL 1: Formation Control of Multiple Nonholonomic Mobile Robots, Takashi Ikeda and three others, IEEJ Transactions D (Industry Applications), 2004, Vol. 124, No. 8, p. 814-819

NPL 2: Leader-following Formation Navigation with Virtual Trajectories for Dynamic Multi-agents, Suzuki Manabu and four others, Transactions of the Institute of Systems, Control and Information Engineers, 2016, Vol. 29, No. 8, p. 382-389

### SUMMARY OF INVENTION

### Technical Problem

For example, in a case where a mobile body moves for a long distance, a function of detecting an obstacle such as an infrared sensor or a GPS or measuring a position of the mobile body is indispensable. In the leader/follower control, only the mobile body serving as the leader has these functions, and the necessity of avoiding the obstacle is determined, or the position of the mobile body is confirmed to measure the difference from the path. Then, the leader instructs the follower to take a future action such as avoidance by using the communication device. The follower can avoid the obstacle without the detection function by performing avoidance according to the instruction of the leader.

Here, the method proposed in NPL 1 has a problem that the target position to be followed by the follower is not smooth in a case where the leader starts to turn after going straight. Many mobile bodies have a restriction of movement such as being unable to swiftly turn, and cannot follow an unsmooth track.

In the method of NPL 2, if the path for the leader is smooth, it is guaranteed that the generated path for the follower is also smooth. However, even in a case where the path for the leader is smooth, there may be a case where the path generated for the follower cannot be followed by the follower.

For example, when the leader turns, the follower outside must move faster than the leader in order to keep the formation and follow the leader. On the other hand, in order for the follower inside the leader to keep the formation and follow the leader, it is necessary to make a small turn, in other words, a sudden turn, than the leader.

An object of the present disclosure is to provide a mechanism for planning a path along which a follower can follow a leader.

### Solution to Problem

In order to achieve the above object, an information processing apparatus according to one aspect of the present disclosure includes
a leader path planning means for setting a dynamic constraint condition for each mobile body in a formation which is controlled such that a leader mobile body causes a follower mobile body to follow, and a path constraint condition for the leader mobile body from relative coordinates between the leader mobile body and the follower mobile body, and generating a path for the leader mobile body in such a manner as to satisfy both the path constraint condition and a waypoint condition concerning a sequence of sets of positions and time points of the leader mobile body on a path, and
a follower path planning means for generating a path for the follower mobile body from a path for the leader mobile body generated by the leader path planning means.

In order to achieve the above object, a control method according to one aspect of the present disclosure causes a computer to execute
setting a dynamic constraint condition for each mobile body in a formation which is controlled such that a leader mobile body causes a follower mobile body to follow, and a path constraint condition for the leader mobile body from relative coordinates between the leader mobile body and the follower mobile body, and generating a path for the leader mobile body in such a manner as to satisfy both the path constraint condition and a waypoint condition concerning a sequence of sets of positions and time points of the leader mobile body on a path, and
generating a path for the follower mobile body from a path for the leader mobile body generated by the leader path planning means.

Furthermore, in order to achieve the above object, a computer-readable recording medium according to one aspect of the present disclosure causes a computer to execute
setting a dynamic constraint condition for each mobile body in a formation which is controlled such that a leader mobile body causes a follower mobile body to follow, and a path constraint condition for the leader mobile body from relative coordinates between the leader mobile body and the follower mobile body, and generating a path for the leader mobile body in such a manner as to satisfy both the path constraint condition and a waypoint condition concerning a sequence of sets of positions and time points of the leader mobile body on a path, and
generating a path for the follower mobile body from a path for the leader mobile body generated by the leader path planning means.

### Advantageous Effects of Invention

As described above, according to the present disclosure, it is possible to plan a path along which a follower can follow a leader.

### BRIEF DESCRIPTION OF DRAWINGS

FIG. 1 is a diagram for explaining an example of an information processing apparatus according to a first example embodiment.

FIG. 2 is a diagram for more specifically explaining an example of the information processing apparatus according to the first example embodiment.

FIG. 3 is a diagram for explaining an example of relative coordinates of a leader mobile body and a follower mobile body.

FIG. 4 is a diagram for explaining an example of a positional relationship between a leader mobile body and a follower mobile body.

FIG. 5 is a diagram for explaining an example of a turning radius of a leader mobile body and a follower mobile body.

FIG. 6 is a diagram for explaining an example of an operation of the information processing apparatus according to the first example embodiment.

FIG. 7 is a diagram for explaining an example of a path for a leader mobile body generated in a first example.

FIG. 8 is a diagram for explaining an example of a path for a follower mobile body generated in the first example.

FIG. 9 is a diagram for explaining an example of a computer that implements the first example embodiment and the first example.

### EXAMPLE EMBODIMENT

### First Example Embodiment

Hereinafter, an example embodiment will be described with reference to the drawings. In the drawings described below, elements having the same function or relevant functions are denoted by the same reference signs, and repeated description thereof may be omitted.

### [Apparatus Configuration]

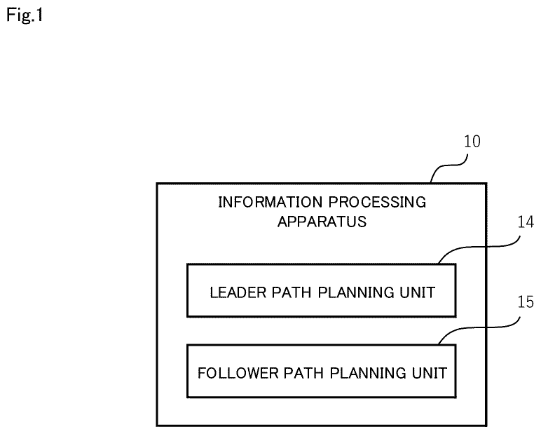

FIG. 1 is a diagram for explaining an example of an information processing apparatus according to a first example embodiment. As illustrated in FIG. 1, an information processing apparatus 10 includes a leader path planning unit 14 and a follower path planning unit 15.

The leader path planning unit 14 sets a path constraint condition of a leader mobile body 20a from a dynamic constraint condition of each of the mobile bodies 20a and 20b in a formation controlled such that the leader mobile body 20a causes the follower mobile body 20b to follow and the relative coordinates of the leader mobile body 20a and the follower mobile body 20b, and generates a path for the leader mobile body 20a so as to satisfy both the path constraint condition and a waypoint condition concerning a sequence of sets of positions and time points of the leader mobile body 20a on the path. The leader path planning unit 14 functions as a leader path planning means.

The follower path planning unit 15 generates a path for the follower mobile body 20b from the path for the leader mobile body 20a generated by the leader path planning unit 14. The follower path planning unit 15 functions as a follower path planning means.

In the first example embodiment, it is possible to plan the path for the follower mobile body 20b that can follow the leader mobile body 20a from the path for the leader mobile body 20a generated as described above. The mobile bodies 20a and 20b are, for example, a movable robot, an automatic guided vehicle, an automatic traveling vehicle, an automatic flying body, an automatic traveling vessel, and the like.

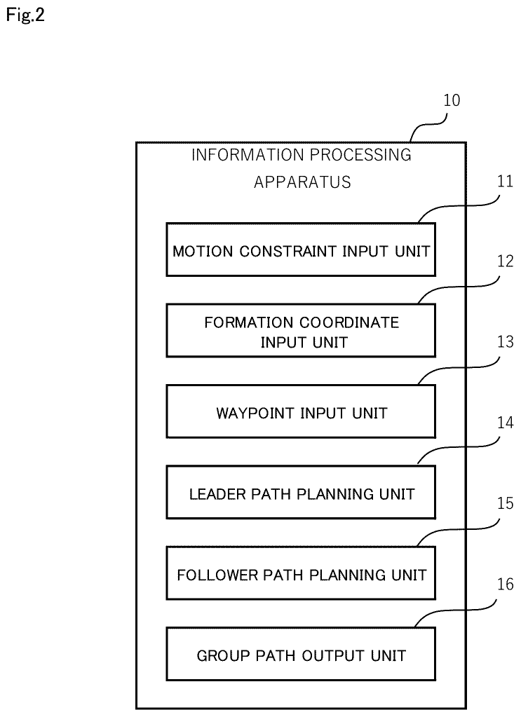

FIG. 2 is a diagram for more specifically explaining an example of the information processing apparatus according to the first example embodiment. As illustrated in FIG. 2, the information processing apparatus 10 may further include a dynamic constraint acquisition unit 11, a formation coordinate acquisition unit 12, a waypoint acquisition unit 13, and a group path output unit 16.

The dynamic constraint acquisition unit 11 receives an input of a dynamic constraint condition of each of the mobile bodies 20a and 20b. The constraint at the time of movement is, for example, maximum/minimum speeds, maximum/minimum accelerations, a minimum turning radius, or the like. The minimum turning radius is a radius of a circle that can be turned when the mobile body makes a sharp turn.

The formation coordinate acquisition unit 12 receives an input of relative coordinates of each follower mobile body 20b with the leader mobile body 20a. The relative coordinates (relative position) are, for example, an input such as (−10 m, 5 m).

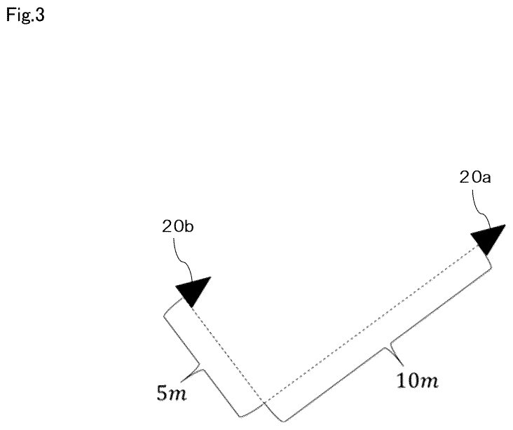

FIG. 3 is a diagram illustrating an example of relative coordinates of the leader mobile body and the follower mobile body. As illustrated in FIG. 3, the relative coordinates mean a position 10 m behind in the direction of the leader mobile body 20a and 5 m in a direction rotated counterclockwise by 90 degrees from the direction of the leader mobile body 20a. The shape of the formation including the leader mobile body 20a and the follower mobile body 20b is determined by the relative coordinates.

The waypoint acquisition unit 13 receives an input of a sequence of sets of coordinates (positions) and time points serving as a base of a path for the leader mobile body 20a. A set of coordinates and time point is referred to as a waypoint. The waypoint represents a goal of reaching a designated coordinate at a designated time point. By specifying the waypoints as a sequence such as [wp₁, wp₂, wp₃, . . . ], it is possible to know via which point the user should move.

That is, the leader mobile body 20a represents a rough path in which the coordinate designated by wp reaches the designated time point, the coordinate designated by wp₂ next reaches the designated time point, and then the coordinate designated by wp₃ reaches the designated time point.

Then, in the information processing apparatus 10 including these, the dynamic constraint condition of each of the mobile bodies 20a and 20b input to the dynamic constraint acquisition unit 11, the relative coordinates of the leader mobile body 20a and the follower mobile body 20b input to the formation coordinate acquisition unit 12, and the waypoint condition concerning the sequence of the sets of the positions and the time points on the path input to the waypoint acquisition unit 13 are transmitted to the leader path planning unit 14, and the path for the leader mobile body 20a is generated.

The group path output unit 16 outputs the path for the leader mobile body 20a generated by the leader path planning unit 14 and the path for the follower mobile body 20b generated by the follower path planning unit 15. However, when the leader path planning unit 14 cannot calculate a path, the group path output unit 16 outputs information indicating that path generation has not been possible.

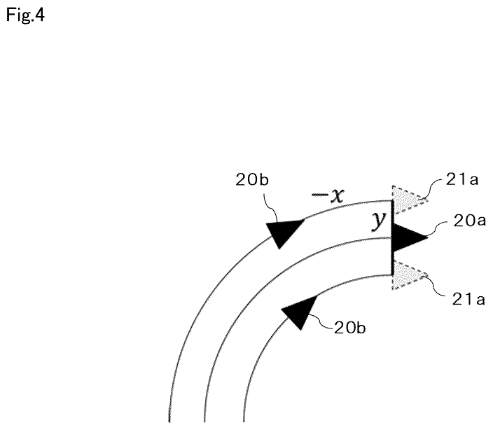

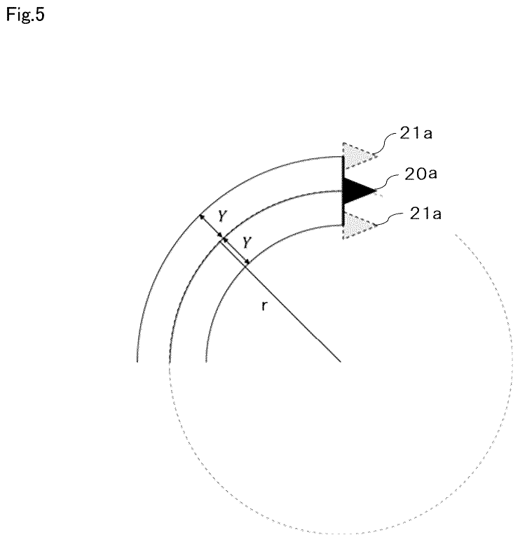

Hereinafter, the configuration and function of the leader path planning unit 14 will be specifically described. FIG. 4 is a diagram for explaining an example of a positional relationship between the leader mobile body and the follower mobile body, and FIG. 5 is a diagram for explaining an example of a turning radius of the leader mobile body and the follower mobile body.

The example illustrated in FIG. 4 illustrates a case where, when the virtual leader mobile body 21a is set at a position shifted from the leader mobile body 20a by the relative coordinates in the y-axis direction in the coordinate system (a moving direction of the leader mobile body 20a is an X axis, and a vertical direction thereof is a Y axis) of the center of the leader mobile body 20a, the follower mobile body 20b moves on a path for following by −1 times the relative coordinates in the x-axis direction on the track on which the virtual leader mobile body 21a passes. FIG. 5 illustrates a turning radius when the leader mobile body 20a turns right, a turning radius of the follower mobile body 20b existing inside the turning of the leader mobile body 20a, and a turning radius of the follower mobile body 20b existing outside the turning of the leader mobile body 20a.

The leader path planning unit 14 generates a smooth path that satisfies the waypoint using an appropriate method. However, at this time, the curvature of the path is limited by the following procedure based on the values input to the dynamic constraint acquisition unit 11 and the formation coordinate acquisition unit 12. The curvature is the reciprocal of the turning radius.

The leader path planning unit 14 calculates, for each of the mobile bodies 20a and 20b, the reciprocal of the sum of the minimum turning radius and the absolute value (O in the case of the leader mobile body 20a) of the value in the y-axis direction of the relative coordinates with respect to the leader mobile body 20a by Expression 2.

$$1 \div ( Minimum turning radius of mobile body + Absolute value of value in y - axis direction of relative coordinates ) \qquad [ Equation 1 ]$$

The leader path planning unit 14 sets the minimum value of the curvature calculated for each of the mobile bodies 20a and 20b as the maximum value of the curvature of the path for the leader. That is, the curvature of the path for the leader mobile body 20a cannot be set to be larger than this maximum value. This is a limitation on the geometry of the path.

The leader path planning unit 14 also limits the speed. The maximum value and the minimum value of the speed of each point on the path trajectory are calculated by the following procedure based on the values input to the dynamic constraint acquisition unit 11 and the formation coordinate acquisition unit 12.

That is, the maximum value and the minimum value of the speed at an optional point p on the path trajectory are calculated. First, the reciprocal of the curvature of the path at the point p, that is, the turning radius is r. Next, the following values are calculated for each of the mobile bodies 20a and 20b.

$$Minimum speed of mobile body \times r \div ( r - Absolute value of y - axis value of relative coordinates of mobile body ) \qquad [ Equation 2 ]$$

$$Maximum speed of mobile body \times r \div ( r + Absolute value of y - axis value of relative coordinates of mobile body ) \qquad [ Equatio n 3 ]$$

Expression 2 is the minimum speed at point p and Expression 3 is the maximum speed. That is, the speed of the leader mobile body 20a at the point p can be set only to a value of Expression 2 or more and Expression 3 or less.

The leader path planning unit 14 further calculates the following values for the acceleration according to a similar procedure.

$$Minimum acceleration of mobile body \times r \div ( r - Absolute value of y - axis value of relative coordinates of mobile body ) \qquad [ Equation 4 ]$$

$$Maximum acceleration of mobile body \times r \div ( r + Absolute value of y - axis value of relative coordinates of mobile body ) \qquad [ Equation 5 ]$$

Expression 4 is the minimum acceleration at point p, and Expression 5 is the maximum acceleration. That is, the acceleration of the leader mobile body 20a at the point p can be set only to a value of Expression 4 or more and Expression 5 or less.

The leader path planning unit 14 calculates constraint conditions (curvature, speed, acceleration) concerning the path for the leader mobile body 20a by the above-described procedure. The leader path planning unit 14 calculates a path that satisfies the constraint conditions concerning the path for the leader mobile body 20a obtained in this manner and satisfies the waypoint conditions concerning the sequence of the sets of positions and time points on the path. For this calculation, a trajectory planning algorithm (dynamic window approach or the like) of a normal mobile body may be used. At this time, a path satisfying the constraint is calculated by inputting, as a model of the mobile body, a model of a virtual mobile body having the constraint calculated in the above-described procedure. However, depending on the values input to the dynamic constraint acquisition unit 11 and the formation coordinate acquisition unit 12, it may be impossible to calculate a path that satisfies the waypoint.

Next, it will be described that a group path output in the first example embodiment is a path that can be followed by each of the leader mobile body 20a and the follower mobile body 20b.

First, it is obvious that the mobile body serving as the leader can follow the output path for the leader mobile body 20a. Since the relative coordinates between the mobile body serving as the leader and the leader mobile body 20a are naturally (0, 0), the values calculated by Expressions 1 to 5 are the reciprocal of the minimum turning radius, the minimum speed, the maximum speed, the minimum acceleration, and the maximum acceleration of the mobile body serving as the leader. Since satisfying all of them is the same as satisfying the dynamic constraint for the mobile body serving as the leader, the output path can be followed by the leader mobile body 20a.

Next, the follower mobile body 20b will be considered. The curvature, the speed, and the acceleration of the path for the follower mobile body 20b fall within the range of the curvature, the speed, and the acceleration of the path for the virtual leader mobile body 21a set at the position shifted from the leader mobile body 20a by the relative coordinates in the y-axis direction in the coordinate system of the leader center.

This is because the follower mobile body 20b merely follows the rear by the relative coordinates in the x-axis direction so as to trace the path for the virtual leader mobile body 21a.

Here, as illustrated in FIG. 5, when the distance in the y-axis direction between the virtual leader mobile body 21a and the leader mobile body 20a is Y, the turning radius (the reciprocal of the curvature) of the path for the virtual leader mobile body 21a is a value obtained by adding Y or subtracting Y from the turning radius of the path for the leader mobile body 20a. If the turning radius of the leader mobile body 20a on the path at the point p is r, the speed is v, and the acceleration is a, the virtual leader mobile body 21a on the outer side moves at the speed (r+Y)/r×v and the acceleration (r+Y)/r×a, and the virtual leader mobile body 21a on the inner side moves at the speed (r−Y)/r×v·(r−Y)/r×a.

In order to simplify the calculation, a situation is considered in which the constraint of the path for the leader mobile body 20a is determined only by the dynamic constraint of one follower mobile body 20b. At this time, the minimum value of the turning radius, the maximum value and the minimum value of the speed, and the maximum value and the minimum value of the acceleration in the output path for the follower mobile body 20b can be calculated as follows based on Expressions 1 to 5 described above.

$$\begin{matrix}Minimum value of turning radius of mobile body \\ \geq Minimum value of turning radius of leader at time of path generation - Y \\ = ( Minimum turning radius of mobile body + Absolute value of relative coordinates in y - axis direction ) - Y \\ = Minimum turning radius of mobile body + Y - Y \\ = Minimum turning radius of mobile body\end{matrix} \qquad [ Equation 6 ]$$

$$\begin{matrix}Minimum value of speed of mobile body \\ \geq Minimum value of speed at time of path generation by leader \times ( ( r - Y ) / r ) \\ = Minimum speed of mobile body \times r \div ( r - Absolute value of y - axis value of relative coordinates of mobile body ) \times ( ( r - Y ) / r ) \\ = Minimum speed of mobile body \times r \div ( r - Y ) \times ( ( r - Y ) / r ) \\ = Minimum speed of mobile body\end{matrix} \qquad [ Equation 7 ]$$

$$\begin{matrix}Maximum value of speed of mobile body \\ \leq Maximum value of speed at time of path generation by leader \times ( ( r + Y ) / r ) \\ = Maximum speed of mobile body \times r \div ( r + Absolute value of y - axis value of relative coordinates of mobile body ) \times ( ( r + Y ) / r ) \\ = Maximum speed of mobile body \times r \div ( r + Y ) \times ( ( r + Y ) / r ) \\ = Maximum speed of mobile body\end{matrix} \qquad [ Equation 8 ]$$

$$\begin{matrix}Minimum value of acceleration of mobile body \\ \leq Minimum value of acceleration at time of path generation by leader \times ( ( r - Y ) / r ) \\ = Minimum acceleration of mobile body \times r \div ( r - Absolute value of y - axis value of relative coordinates of mobile body ) \times ( ( r - Y ) / r ) \\ = Minimum acceleration of mobile body \times r \div ( r - Y ) \times ( ( r - Y ) / r ) \\ = Minimum acceleration of mobile body\end{matrix} \qquad [ Equation 9 ]$$

$$\begin{matrix}Maximum value of acceleration of mobile body \\ \leq Maximum value of acceleration at time of path generation by leader \times ( ( r + Y ) / r ) \\ = Maximum acceleration of mobile body \times r \div ( r + Absolute value of y - axis value of relative coordinates of mobile body ) \times ( ( r + Y ) / r ) \\ = Maximum acceleration of mobile body \times r \div ( r + Y ) \times ( ( r + Y ) / r ) \\ = Maximum acceleration of mobile body\end{matrix} \qquad [ Equation 10 ]$$

From the above calculation result, the path for the follower mobile body 20b generated from the path for the leader mobile body 20a generated by the leader path planning unit 14 satisfies the dynamic constraint of the follower mobile body 20b. Since the leader path planning unit 14 actually determines the constraint condition concerning the path for the leader mobile body 20a based on the dynamic constraint conditions of the plurality of follower mobile bodies 20b, the most severe condition among all the follower mobile bodies 20b is adopted for each condition. For this reason, a path satisfying the dynamic constraint is also generated for the follower mobile body 20b not adopted as the constraint condition.

The constraint calculated by the leader path planning unit 14 may be only a part of those described above or may be other constraints. For example, it is also conceivable that the minimum turning radius and the like have different values in a case of moving at a high speed and a case of moving at a low speed. In order to cope with this condition, the dynamic constraint acquisition unit 11 may receive an input of the minimum turning radius for each speed. Even in such a case, it is possible to easily set the constraint by calculating the curvature, the speed, and the acceleration of the virtual leader mobile body 21a from the curvature, the speed, and the acceleration of the leader mobile body 20a, and obtaining the constraint condition by back calculation.

### [Apparatus Operation]

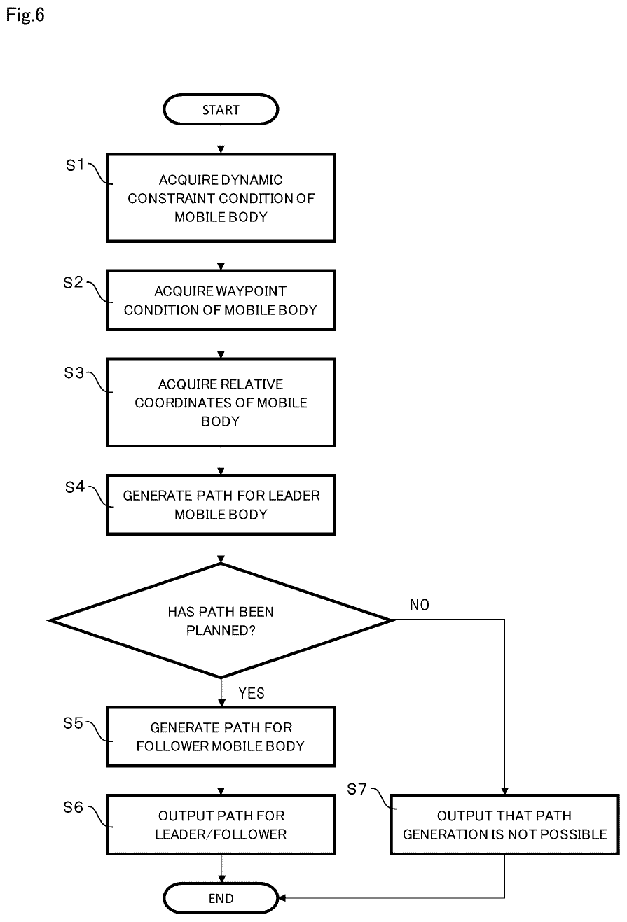

Next, the operation of information processing apparatus according to the first example embodiment will be described with reference to FIG. 6. FIG. 6 is a diagram for explaining an example of the operation of the information processing apparatus in the first example embodiment. FIGS. 1 to 5 will be appropriately referred to in the following description. In the first example embodiment, the control method is performed by operating the information processing apparatus. Therefore, the description of the control method in the example embodiment is replaced with the following description of the operation of the information processing apparatus.

As illustrated in FIG. 6, first, the dynamic constraint acquisition unit 11 receives and acquires the input of the dynamic constraint condition of each of the mobile bodies 20a and 20b in a formation (step S1). The waypoint acquisition unit 13 receives and acquires the input of the waypoint condition concerning the sequence of the sets of the positions and the time points of the leader mobile body 20a on the path (step S2). The formation coordinate acquisition unit 12 receives and acquires relative coordinates of the leader mobile body 20a and the follower mobile body 20b (step S3).

Thereafter, the leader path planning unit 14 sets a path constraint condition regarding the path for the leader mobile body 20a from a dynamic constraint condition of each of the mobile bodies 20a and 20b in a formation controlled such that the leader mobile body 20a causes the follower mobile body 20b to follow and the relative coordinates of the leader mobile body 20a and the follower mobile body 20b, and generates a path for the leader mobile body 20a so as to satisfy both the path constraint condition and a waypoint condition concerning a sequence of sets of positions and time points of the leader mobile body 20a on the path (step S4). Next, the follower path planning unit 15 generates a path for the follower mobile body 20b from the path for the leader mobile body 20a generated by the leader path planning unit 14 (step S5).

Subsequently, when the leader path planning unit 14 has been able to generate the path for the leader mobile body 20a, the group path output unit 16 outputs the path for the leader mobile body 20a and the path for the follower mobile body 20b (step S6). On the other hand, in a case where the leader path planning unit 14 has not been able to generate the path for the leader mobile body 20a, the group path output unit 16 does not perform the path planning for the followers and outputs information indicating that the path generation has not been possible (step S7).

### First Example

The first example embodiment will be described more specifically with the following conditions as examples.
(Dynamic Constraint Condition)
Minimum turning radius=10 m for leader and all followers in common
Maximum speed=10 m/s for leader and all followers in common
Minimum speed=1 m/s for leader and all followers in common
(Assuming that there is no restriction on acceleration)
(Waypoint condition)
   [Coordinates (0, 0), time point: 0 seconds]
   [Coordinates (20, 0), time point: 2 seconds]
   [Coordinates (35,10), time point: 6 seconds]
(Relative coordinates of follower mobile body)
Relative coordinates of follower 1=(−5, −5)
Relative coordinates of follower 2=(−5, 3)

The leader path planning unit 14 generates a path based on the Dubins path. The Dubins path is a path including only an arc having the same radius as the straight line, is compatible with the information processing apparatus 10, and can easily calculate the constraint condition. Specifically, the leader path planning unit 14 determines the radius of the arc from the result of calculation by substituting the above condition into Expression 1. The leader path planning unit 14 determines the speed of the leader mobile body 20a from the calculation result obtained by dividing the path into the straight linear portion and the arc portion and substituting the above conditions into Expressions 2 and 3.

Since the maximum value of the curvature is the minimum value of Expression 1 in each mobile body, the maximum value of the curvature is expressed by the following Expression 11.

$$min \{ \frac{1}{10 + \vert 0 \vert} , \frac{1}{10 + \vert - 5 \vert} , \frac{1}{10 + \vert 3 \vert} \} = \frac{1}{15} \qquad [ Equation 11 ]$$

This is synonymous with that the minimum value of the turning radius in the path for the leader mobile body 20a is 15. That is, the radius of the arc of the Dubins path needs to be 15 m or more. Here, the turning radius in the path for the leader mobile body 20a is set to 15 m.

In the calculation of the linear portion, the curvature is 0, and the turning radius is infinite. Therefore, if the property that r in Expressions 2 and 3 is infinite and ∞/(∞+constant)=1 is used, Expressions 2 and 3 simply calculate the maximum/minimum speeds of the mobile body. That is, the speed constraint of the path for the leader mobile body 20a in the linear portion is given as follows. Since the curvature is 1/15 from Expression 11, the speed constraint of the path for the leader mobile body 20a in the arc portion is given as follows.

$$\begin{matrix}Minimum value of speed in linear portion of path \\ = Minimum speed of mobile body \\ = 1 m / s\end{matrix}$$

$$\begin{matrix}Maximum value of speed in linear portion of path \\ = Maximum speed of mobile body \\ = 10 m / s\end{matrix}$$

$$\begin{matrix}Minimum value of speed in arc portion of path \\ = Minimum speed of mobile body \times 15 / ( 15 - 5 ) \\ = 1.5 m / s\end{matrix}$$

$$\begin{matrix}Maximum value of speed in arc portion of path \\ = Maximum speed of mobile body \times 15 / ( 15 + 5 ) \\ = 7.5 m / s\end{matrix}$$

As described above, the constraint condition concerning the path for the leader mobile body 20a can be determined. Next, the path for the leader mobile body 20a is calculated so as to satisfy both the constraint condition concerning the path for the leader mobile body 20a and the waypoint condition concerning the sequence of the sets of the positions and the time points on the path.

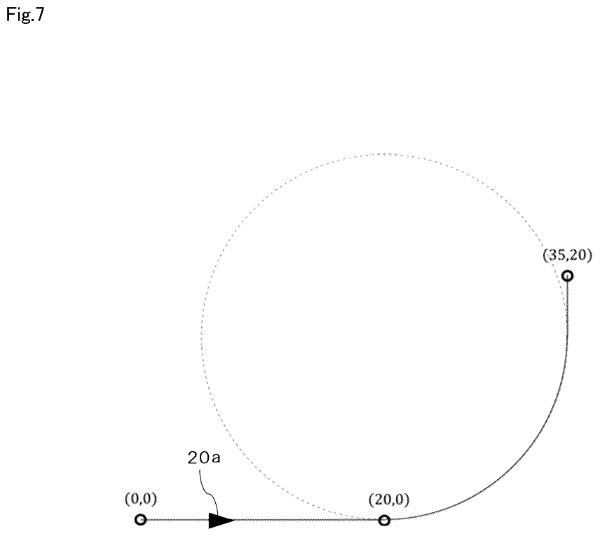

FIG. 7 is a diagram for explaining an example of a path for a leader mobile body generated in the first example embodiment. Regarding the waypoint condition, the shape of the path for the leader mobile body 20a set based on the Dubins path in a case where the radius of the arc is 15 m is as illustrated in FIG. 7. Next, the speed is calculated. In order to leave the first waypoint coordinates (0, 0) at time point 0 and arrive at the coordinates (20, 0) of the second waypoint at time point of 2 seconds, it is only required to move the first straight line at 20/2=10 m/s. Since 10 m/s is equal to or more than the minimum value and equal to or less than the maximum value of the speed in the linear portion, the first and second waypoints can be satisfied without violating the constraint.

The path length from the second waypoint to the third waypoint is expressed by the following Expression 12.

$$\frac{15 π}{2} + 5 \qquad [ Equation 12 ]$$

In Expression 12, the first item is the length of the arc, and the second item is the length of the straight line. Considering that the vehicle moves on the path from the second waypoint to the third waypoint at a constant speed, the speed is about 7.14 m/s as expressed in the following Expression 13.

$$( \frac{15 π}{2} + 5 ) \div ( 6 - 2 ) \approx 7.14 m / s \qquad [ Equation 13 ]$$

This speed is within the maximum value and the minimum value of the speeds of the linear portion and the arc portion of the path, and thus satisfies the constraint. Therefore, the path for the leader mobile body 20a has a shape as illustrated in FIG. 7, and is calculated as a path in which the mobile body moves on the first straight line at 10 m/s and moves on the subsequent arc and straight line at 7.14 m/s.

The follower path planning unit 15 calculates the path for each follower mobile body 20b from the path for the leader mobile body 20a.

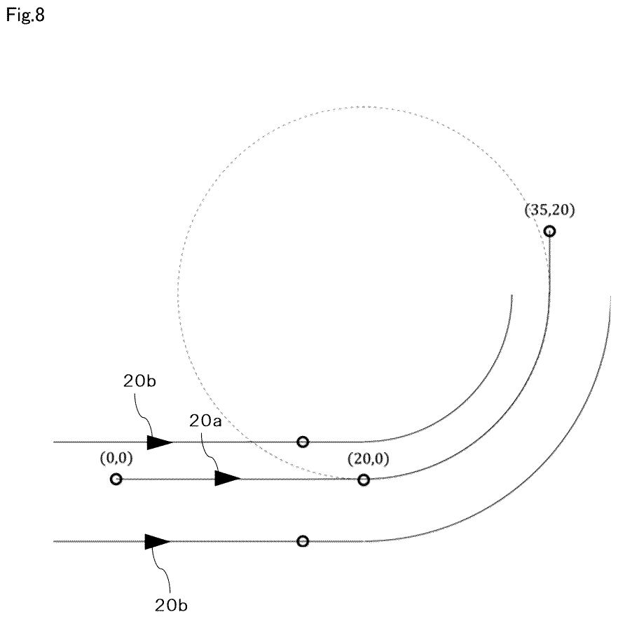

FIG. 8 is a diagram for explaining an example of a path for a follower mobile body generated in the first example embodiment. The path for the follower mobile body 20b generated from the path for the leader mobile body 20a has a shape as illustrated in FIG. 8. A circle on the path for the follower mobile body 20b in FIG. 8 represents points at which the speed changes on the path.

The speed of the follower mobile body 20b turning inside is 10 m/s before the circle, and is about 5.71 m/s after the circle as in the following Expression 14.

$$7.14 \times ( 15 - 3 ) / 15 \approx 5.71 m / s \qquad [ Equation 14 ]$$

On the other hand, the path for the follower mobile body 20b turning outside is 10 m/s before the circle, and is about 9.52 m/s after the circle as in the following Expression 15.

$$7.14 \times ( 15 + 5 ) / 15 \approx 9.52 m / s \qquad [ Equation 15 ]$$

It can be seen that the speed of the follower mobile body 20b on any path is within the maximum and minimum moving speeds of the mobile body.

In this manner, the information processing apparatus 10 can generate the path for the leader mobile body 20a and the path for the follower mobile body 20b that can follow the leader mobile body 20a, which is useful in the case of moving a plurality of mobile bodies forming a formation by the leader/follower control.

In the present example embodiment, a storage unit may be provided. The storage unit may be achieved by storing data files constituting the storage unit in a storage device such as a hard disk provided in a computer, or may be achieved by a storage device of another computer.

Examples of the computer include a smartphone and a tablet terminal device in addition to a general-purpose PC.

The program in the present example embodiment may be executed by a computer system constructed by a plurality of computers. In this case, for example, each computer may function as either the leader path planning unit 14 or the follower path planning unit 15.

### [Program]

A program in the first example embodiment may be a program that causes a computer to execute steps S1 to S7 illustrated in FIG. 6. When the program is installed and executed in the computer, the information processing apparatus and the control method according to the first example embodiment can be achieved. In this case, the processor of the computer functions as the dynamic constraint acquisition unit 11, the formation coordinate acquisition unit 12, the waypoint acquisition unit 13, the leader path planning unit 14, the follower path planning unit 15, and the group path output unit 16, and performs processing.

Further, the program in the first example embodiment may be executed by a computer system constructed by a plurality of computers. In this case, for example, each computer may function as any of the dynamic constraint acquisition unit 11, the formation coordinate acquisition unit 12, the waypoint acquisition unit 13, the leader path planning unit 14, the follower path planning unit 15, and the group path output unit 16.

### [Physical Configuration]

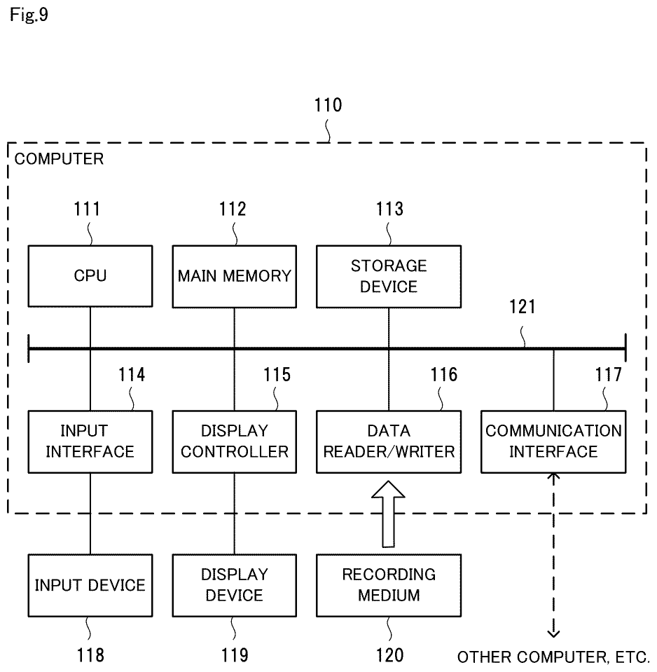

Here, a computer that implements the information processing apparatus 10 by executing the program in the first example embodiment will be described with reference to FIG. 9. FIG. 9 is a block diagram illustrating an example of a computer that implements the information processing apparatus 10 according to the first example embodiment.

As illustrated in FIG. 9, a computer 110 includes a central processing unit (CPU) 111, a main memory 112, a storage device 113, an input interface 114, a display controller 115, a data reader/writer 116, and a communication interface 117. These units are data-communicably connected to each other via a bus 121.

The computer 110 may include a graphics processing unit (GPU) or a field-programmable gate array (FPGA) in addition to the CPU 111 or instead of the CPU 111. In this aspect, the GPU or the FPGA can execute the program in the example embodiment.

The CPU 111 develops the program according to the example embodiment, which is stored in the storage device 113 and configured by a code group, in the main memory 112, and executes each code in a predetermined order to perform various operations. The main memory 112 is typically a volatile storage device such as a dynamic random access memory (DRAM).

In addition, the program according to the example embodiment is provided in a state of being stored in a computer-readable recording medium 120. The program in the present example embodiment may be distributed on the Internet connected via the communication interface 117.

Specific examples of the storage device 113 include a semiconductor storage device such as a flash memory in addition to a hard disk drive. The input interface 114 mediates data transmission between the CPU 111 and the input device 118 such as a keyboard and a mouse. The display controller 115 is connected to a display device 119 and controls display on the display device 119.

The data reader/writer 116 mediates data transmission between the CPU 111 and the recording medium 120, and reads a program from the recording medium 120 and writes a processing result in the computer 110 to the recording medium 120. The communication interface 117 mediates data transmission between the CPU 111 and another computer.

Specific examples of the recording medium 120 include general-purpose semiconductor storage devices such as Compact Flash (CF) (registered trademark) and a secure digital (SD), a magnetic recording medium such as a flexible disk, and an optical recording medium such as a compact disk read only memory (CD-ROM).

The information processing apparatus 10 according to the example embodiment can also be achieved by using hardware related to each unit, for example, an electronic circuit, instead of the computer in which the program is installed. Furthermore, a part of the information processing apparatus 10 may be achieved by a program, and the remaining part may be achieved by hardware. In the example embodiment, the computer is not limited to the computer illustrated in FIG. 9.

Some or all of the above-described example embodiments can be expressed by (Supplementary Note 1) to (Supplementary Note 9) described below, but are not limited to the following description.

### (Supplementary Note 1)

An information processing apparatus including:
a leader path planning means for setting a dynamic constraint condition for each mobile body in a formation which is controlled such that a leader mobile body causes a follower mobile body to follow, and a path constraint condition for the leader mobile body from relative coordinates between the leader mobile body and the follower mobile body, and generating a path for the leader mobile body in such a manner as to satisfy both the path constraint condition and a waypoint condition concerning a sequence of sets of positions and time points of the leader mobile body on a path; and
a follower path planning means for generating a path for each of the follower mobile bodies from a path for the leader mobile body generated by the leader path planning means.

### (Supplementary Note 2)

The information processing apparatus according to Supplementary Note 1, in which
the leader path planning means calculates constraint conditions including curvature, speed, and acceleration at an optional point on a path for each of the mobile bodies based on a minimum turning radius, maximum/minimum speeds, and maximum/minimum accelerations of each of the mobile bodies, and generates a path for the leader mobile body.

### (Supplementary Note 3)

The information processing apparatus according to Supplementary Note 2, in which
the leader path planning means generates a path for the leader mobile body by a combination of a straight line and an arc based on a Dubins path.

### (Supplementary Note 4)

A control method by a computer, the control method including:
setting a dynamic constraint condition for each mobile body in a formation which is controlled such that a leader mobile body causes a follower mobile body to follow, and a path constraint condition for the leader mobile body from relative coordinates between the leader mobile body and the follower mobile body, and generating a path for the leader mobile body in such a manner as to satisfy both the path constraint condition and a waypoint condition concerning a sequence of sets of positions and time points of the leader mobile body on a path; and
generating a path for each of the follower mobile bodies from a generated path for the leader mobile body.

### (Supplementary Note 5)

The control method according to Supplementary Note 4, further including
calculating constraint conditions including curvature, speed, and acceleration at an optional point on a path for each of the mobile bodies based on a minimum turning radius, maximum/minimum speeds, and maximum/minimum accelerations of each of the mobile bodies, and generating a path for the leader mobile body.

### (Supplementary Note 6)

The information processing apparatus according to Supplementary Note 5, in which
a path is generated for the leader mobile body by a combination of a straight line and an arc based on a Dubins path.

### (Supplementary Note 7)

A computer-readable recording medium having recorded therein a program including instructions for causing a computer to execute:
setting a dynamic constraint condition for each mobile body in a formation which is controlled such that a leader mobile body causes a follower mobile body to follow, and a path constraint condition for the leader mobile body from relative coordinates between the leader mobile body and the follower mobile body, and generating a path for the leader mobile body in such a manner as to satisfy both the path constraint condition and a waypoint condition concerning a sequence of sets of positions and time points of the leader mobile body on a path; and
generating a path for each of the follower mobile bodies from a generated path for the leader mobile body.

### (Supplementary Note 8)

The computer-readable recording medium according to Supplementary Note 7, further causing the computer to execute
calculating constraint conditions including curvature, speed, and acceleration at an optional point on a path for each of the mobile bodies based on a minimum turning radius, maximum/minimum speeds, and maximum/minimum accelerations of each of the mobile bodies, and generating a path for the leader mobile body.

### (Supplementary Note 9)

The computer-readable recording medium according to Supplementary Note 8, further causing the computer to execute
generating a path for the leader mobile body by a combination of a straight line and an arc based on a Dubins path.

While the present invention has been particularly shown and described with reference to example embodiments thereof, the present invention is not limited to these example embodiments. It will be understood by those of ordinary skill in the art that various changes in form and details may be made therein without departing from the spirit and scope of the present disclosure as defined by the claims.

### INDUSTRIAL APPLICABILITY

As described above, according to the present disclosure, it is possible to plan a path along which a follower can follow a leader.

### REFERENCE SIGNS LIST

10 information processing apparatus
11 dynamic constraint acquisition unit
12 formation coordinate acquisition unit
13 waypoint acquisition unit
14 leader path planning unit
15 follower path planning unit
16 group path output unit
20a leader mobile body
20b follower mobile body
21a virtual leader mobile body
110 computer
111 CPU
112 main memory
113 storage device
114 input interface
115 display controller
116 data reader/writer
117 communication interface
118 input device
119 display device
120 recording medium
121 bus

What is claimed is:

1. An information processing apparatus comprising:
at least one memory storing instructions; and
at least one processor configured to execute the instructions to:
set a dynamic constraint condition for each mobile body in a formation which is controlled such that a leader mobile body causes a follower mobile body to follow, and a path constraint condition for the leader mobile body from relative coordinates between the leader mobile body and the follower mobile body, and generate a path for the leader mobile body in such a manner as to satisfy both the path constraint condition and a waypoint condition concerning a sequence of sets of positions and time points of the leader mobile body on a path; and
generate a path for each of the follower mobile bodies from a path for the leader mobile body generated by the leader path planning means.

2. The information processing apparatus according to claim 1, wherein the one or more processors further:
calculates constraint conditions including curvature, speed, and acceleration at an optional point on a path for each of the mobile bodies based on a minimum turning radius, maximum/minimum speeds, and maximum/minimum accelerations of each of the mobile bodies, and generates a path for the leader mobile body.

3. The information processing apparatus according to claim 2, wherein the one or more processors further:
generates a path for the leader mobile body by a combination of a straight line and an arc based on a Dubins path.

4. A control method by a computer, the control method comprising:
setting a dynamic constraint condition for each mobile body in a formation which is controlled such that a leader mobile body causes a follower mobile body to follow, and a path constraint condition for the leader mobile body from relative coordinates between the leader mobile body and the follower mobile body, and generating a path for the leader mobile body in such a manner as to satisfy both the path constraint condition and a waypoint condition concerning a sequence of sets of positions and time points of the leader mobile body on a path; and
generating a path for each of the follower mobile bodies from a generated path for the leader mobile body.

5. The control method according to claim 4, further comprising calculating constraint conditions including curvature, speed, and acceleration at an optional point on a path for each of the mobile bodies based on a minimum turning radius, maximum/minimum speeds, and maximum/minimum accelerations of each of the mobile bodies, and generating a path for the leader mobile body.

6. The control method according to claim 5, further comprising generating a path for the leader mobile body by a combination of a straight line and an arc based on a Dubins path.

7. A non-transitory computer-readable recording medium having recorded therein a program including instructions for causing a computer to execute:
setting a dynamic constraint condition for each mobile body in a formation which is controlled such that a leader mobile body causes a follower mobile body to follow, and a path constraint condition for the leader mobile body from relative coordinates between the leader mobile body and the follower mobile body, and generating a path for the leader mobile body in such a manner as to satisfy both the path constraint condition and a waypoint condition concerning a sequence of sets of positions and time points of the leader mobile body on a path; and
generating a path for each of the follower mobile bodies from a generated path for the leader mobile body.

8. The non-transitory computer-readable recording medium according to claim 7, further causing the computer to execute calculating constraint conditions including curvature, speed, and acceleration at an optional point on a path for each of the mobile bodies based on a minimum turning radius, maximum/minimum speeds, and maximum/minimum accelerations of each of the mobile bodies, and generating a path for the leader mobile body.

9. The non-transitory computer-readable recording medium according to claim 8, further causing the computer to execute generating a path for the leader mobile body by a combination of a straight line and an arc based on a Dubins path.
